(19) United States
(12) Patent Application Publication
(10) Pub. No.: US 2003/0066093 A1
(43) Pub. Date: Apr. 3, 2003

(54) Methods and apparatus for circular broadcasting an audio and video signal

(76) Inventors: Jose I. Cruz-Rivera, San Juan, PA (US); Miguel Berrios, Guaynabo, PA (US)

Correspondence Address: Patent Law Offices of, Heath W. Hoglund, 256 Eleanor Roosevelt, San Juan, PR, 00918, US

(21) Appl. No.: 10/145,347

(22) Filed: May 13, 2002

Related U.S. Application Data
(60) Provisional application No. 60/290,453, filed on May 11, 2001.

(51) Int. Cl. H04N 7/173; H04N 7/16

(52) U.S. Cl. 725/146; 725/138; 725/116

(57) ABSTRACT

A method of broadcasting a plurality of media to an unlimited number of subscribers through a digital communications network having a limited bandwidth is disclosed. The method selects a first group of digitized media each divided into a plurality of temporally related frames. The method transmits the plurality of temporally related frames of the first group of digitized media through the digital communications network in a compressed format, wherein the transmission includes a header along with each of the plurality of temporally related frames wherein the header identifies the temporal sequence of the frames. The method retransmits the plurality of temporally related frames of the first group of digitized media through the digital communications network in the compressed format immediately upon completion of the step of transmitting the plurality of temporally related frames of the first group of digitized media.

### BACKGROUND OF THE INVENTION

Various methods and apparatus for broadcasting a video-on-demand are known in the art. Details such methods are described by:

(1) G. O'Driscoll, “The Essential Guide to Digital Set-Top Boxes and Interactive TV,” Prentice Hall, 2000 (reference 1), and

(2) W. Wright, “An Efficient Video-on-Demand Model,” IEEE Computer, pp. 64-70, May 2001 (reference 2).

Both of the above references are incorporated herein by reference in their entirety.

### SUMMARY OF THE INVENTION

According to one aspect of the invention, a plurality of movies or other media are broadcast to an unlimited number of subscribers through a digital communications network having a limited bandwidth. A broadcaster selects a first group of digitized movies each divided into a plurality of temporally related frames. The broadcaster transmits the plurality of temporally related frames of the first group of digitized movies through the digital communications network in a compressed format. The broadcaster includes a header along with each of the plurality of temporally related frames. The header identifies the temporal sequence of the frames. The broadcaster then re-transmits the plurality of temporally related frames of the first group of digitized movies through the digital communications network in the compressed format immediately upon completion of the previous transmission.

According to a further aspect of the invention, the broadcaster receives at least one request for each movie in a second group of digitized movies each divided into a plurality of temporally related frames. The broadcaster transmits the second group of digitized movies without repetition only once in a fixed period of time. The fixed period of time that is greater than the time of transmission.

According to a further aspect of the invention, a set-top box is configured to store and regenerate a movie signal received from the broadcaster from either of the above-stated methods of transmission.

According to another aspect of the invention, a set-top box is suitable to receive a compressed video signal. The set-top box includes a receiver configured to accept compressed video signals that are divided into frames and include a sequence header. The set-top box includes a memory operationally coupled with the receiver and configured to store the compressed video signals. The set top box includes an interface configured to receive a movie selection from a user. The set-top box also includes a controller operationally coupled with the receiver. The memory and the user interface and configured to direct the receiver to accept immediately the movie selection from a repeated broadcast of a plurality of movies.

According to a further aspect of the invention, the set-top box further includes a transmitter operationally coupled with the controller. The controller is further configured to transmit a request for the movie selection from the user to a service provider and to direct the receiver to accept the movie selection from a single broadcast of the selected movie in a fixed period of time.

### DETAILED DESCRIPTION OF THE INVENTION

The following description presents a novel solution for True-Video-on-Demand (T-VoD) services. The solution allows service providers a very flexible means by which to structure their business models. The proposed CircularBroadcast™ technique is a radical departure from current streaming VoD models that devote system bandwidth to individual users for the duration of a movie experience, thus limiting the number of subscribers that can simultaneously access the service. The CircularBroadcast™ technology can be thought of as an extension of current broadcast TV models in the sense that a provider continuously broadcasts a signal (in this case a compressed digital file) that can be tapped by anyone who has access-rights to the channel. The bandwidth used during this broadcast can be shared by an unlimited number of users. There is no one-to-one bandwidth allocation involved.

CircularBroadcast™ effectively allows an unlimited number of subscribers to enjoy T-VoD services, while at the same time lowering the bandwidth resources needed to serve a specific movie library, as compared to streaming VoD models. In fact, the CircularBroadcast™ model allows a service provider the ability to leverage from movie access statistics in order to maximize the use of available bandwidth during off-peak hours.

The CircularBroadcast™ model does not pose any stringent demands on set-top boxes, beyond the requirement for enough high-capacity (e.g., hard-disk) storage space to store at least a single compressed movie. The minimum required storage capacity to store N movies is H=NL, where L is the average movie length. Since movies are downloaded onto the set-top-box, full VCR-like functionality is available (Fast-Forward, Rewind, Start, Stop, Slow-Motion, etc.) Standard encryption and file time-stamping techniques are used to protect the copyrights associated with all downloaded materials.

The following description presents a high-level overview of the CircularBroadcast™ technique. It then presents an overview of the state-of-the-art in current streaming VoD models in order to define a standard against which to benchmark the proposed technique. Next it presents the general concepts that define the CircularBroadcast™ technique and presents a mathematical description of its performance capabilities. Finally, it presents the NowVideo™ and AlwaysVideo™ service models enabled by the proposed technique.

1. VOD Streaming

In the following description, a VoD streaming system is modeled as the interconnection of many subscriber terminals to a single movie server via a communication network. The terminals are attached to a TV and are in charge of submitting movie requests to the server via the communications network. The server accesses a large disk array that contains the digitized and compressed movie files from which subscribers may select and sends bursts of data from the selected movie file to the subscriber's terminal, as shown in FIG. 8.7 in reference 1, above. The terminals buffer a short sequence of the movie in local memory and proceed to decompress the data received, providing it in real-time to the subscriber's TV set.

An important part of any VoD streaming model is the serving algorithm. This algorithm must be optimized to ensure that the sequence of disk reads is as efficient as possible so as to permit the maximum number of simultaneous streams that can be served without starving any subscriber terminals. It has been determined that serving terminals in rounds (where at most one data block is served to each terminal during each round) maximizes overall system performance.

The OEID model (one-way elevator with interleaving and delayed start) has recently been presented in reference 2, above, as an efficient video-on-demand model that permits an almost perfectly balanced workload across all disks in a movie library, regardless of movie popularity—albeit to a limited number of subscribers. The OEID model includes a scheduling algorithm, buffer policy, file-storage layout, and a feedback mechanism for denying new requests when the system becomes nearly saturated.

In the OEID model interleaving and striping techniques are used to distribute a movie library over multiple disks. The striping technique synchronizes the seek, latency, and transfer times associated with each disk. The logical block read during a particular access is the concatenation of all the individual stripe blocks on each disk. Interleaving, on the other hand, stores an entire block on a single disk, but distributes successive blocks across all disks. Table 1 presents the interleaving concept for a library consisting of 400 movies distributed across 100 disks.

The OEID algorithm “functions like an elevator that goes from the bottom to the top floor, making stops as needed at floors along the way, but then drops as fast as possible to the bottom floor without stopping or slowing down. During a round, the reading of each disk proceeds approximately from the outermost cylinder and lowest track number needing to be read to the innermost cylinder and highest track number needing to be read. Following this process, a full-stroke seek back to the outermost cylinder needing to be read positions the arm for the next round.” (See reference 1, above.)

The following Table 1 shows interleaving of 400 movies over 100 disks. Striping is done within each block on each disk. In this example, a movie file is segmented into 200 blocks of data and successively distributed across the 100 available disks.

TABLE 1

| | Disk 1 | Disk 2 | . . . | Disk 100 |
|---|---|---|---|---|
| | Block 1 | Block 2 | . . . | Block 100 |
| Movie 1 | Block 101 | Block 102 | . . . | Block 200 |
| . . . | | | | |
| | Block 1 | Block 2 | . . . | Block 100 |
| Movie 400 | Block 101 | Block 102 | . . . | Block 200 |
| | . . . | | | |

The capabilities of the OEID model can be garnered from the following mathematical analysis, where the consumption rate of (MPEG-2) compressed data at a subscriber's terminal is CR=0.5 MB/s, the average movie file occupies L=3.6 GB (2-hour movie), a disk can provide data at a transfer rate of TR=20 MB/s, disk capacity is d=16 GB, and the total number of disks available at the server is m=100 (thus allowing a 400-movie catalog to be offered to service subscribers).

The number of simultaneous streams, n, that can be supported by the OEID model can be calculated as follows. Let the logical block size b=0.5 MB. Since m=100, the stripe size is b/m=5 KB. Let s be the effective average seek time for a disk access, including the settle time, r be the average disk latency, and tt be the average transfer time. The average total access time is then given as a=s+r+tt. If r=4 ms, b/TR=25 ms, and s=2 ms, then a=31 ms.

The amount of time available for reading blocks from disks depends on the full-stroke seek time (maximum seek time of a disk), sₘ. If sₘ=15 ms, then in an m=100 disk system the available time for reading blocks is b/CR−sₘ=985 ms. Thus, the maximum number of streams that can be supported by a single disk is 985/31=32. Since 100 disks are available, the maximum number of streams that may be supported by the system would be n=3200.

According to the OEID model, “the system either starts the streams at relatively random times or randomizes the starting disks for the different movies. Hence the average number of streams that each disk serves during each round equals the total number of streams divided by the number of disks, evenly distributing the workload regardless of movie popularity.” (See reference 2, above.) Slightly delayed starts can be used to ensure the even workload distribution, along with a warning message from a terminal when it is nearing starvation. Using the previously defined values, the maximum delay that a user would experience from the time he selects a movie until he can start watching it would thus be m×b/CR=100 seconds.

The bottom line for the OEID model previously examined is that, provided the communications network can sustain the required CR=0.5 MB/s (4.0 Mb/s) transmission to each subscriber terminal, the server and disk system discussed can support up to 3,200 streams. What this means is that at any given time up to 3,200 subscribers could enjoy a VoD experience across the full movie catalog. However, this holds only if the network can sustain the bandwidth requirements of 3,200 subscribers. This is a major “if”, when one considers, for example, the case of a VoD provider using a digital via hybrid fiber coax Cable TV infrastructure. Under this scenario, the provider would only have BW=38.4 Mb/s of bandwidth per channel, requiring a total of Cmax=┌(n×CR)/BW┐320 channels to serve the 3,200 subscribers dictated by the server-limited numbers previously developed for the OEID model.

To summarize our findings to this point, the following equations show the actual number of streams that can be supported (which in this case equals the number of subscribers that can be served concurrently), n, the number of channels required to sustain the server-limited maximum number of streams, Cmax, and the maximum wait time for the video to be served, WT.

$$\text{Equation 1:}$$

$$n = max [ m \cdot \frac{b / CR - {s}_{m}}{s + r + tt} , \frac{C \cdot BW}{CR} ]$$

Equation 2:

Cₘₐₓ=n·CR/BW

Equation 3:

WT=m·b/CR

In Equation 1, the first term inside the square brackets is the server-limited number of streams, while the second term is the network bandwidth limited number of streams. As mentioned previously, m is the number of disks available, b is the block rate, CR is the consumption rate at the terminal end, sₘ is the maximum disk seek time, s is the effective average disk seek time, r is the disk latency, tt is the disk transfer rate, C is the number of channels available, and BW is the available bandwidth per channel.

The OEID model is a very efficient way to handle streaming VoD implementations, particularly because it guarantees a turn-around time (wait-time) of at most m×b/CR seconds regardless of the relative popularity of movies within the offered catalog. However, The drawback of the model is that the number of subscribers that can enjoy the VoD experience at any one time is limited by the number of streams that the server can handle or alternatively by the amount of network bandwidth available. The number of streams may be increased by enlarging the block size, b, at the expense of RAM requirements for buffers at both the server side and the terminal side. The problem, in essence, is that the system must establish a one-to-one relationship with the subscriber in order to function as a T-VOD system, a direct result of the streaming model itself.

2. CircularBroadcast™ Technique

The CircularBroadcast™ Technique addresses the limitations of current streaming models for VoD applications. The salient point of this technique is that it can allow a service provider the ability to serve a movie library (or any other type of digital content) to an unlimited number of subscribers using less bandwidth than is currently needed by streaming VoD models. The CircularBroadcast™ technique allows a service provider the ability to leverage from movie access statistics in order to maximize the use of available bandwidth during off-peak hours. The only difference in the required infrastructure is that the set-top boxes must include a hard disk (or other high-capacity storage device) to store at least one full movie file. Current industry trends indicate that hard disk storage is rapidly becoming the norm in set-top-boxes. Since under the CircularBroadcast™ model the movies are downloaded onto the set-top-box, full VCR-like functionality is available (Fast-Forward, Rewind, Start, Stop, Slow-Motion, etc.)

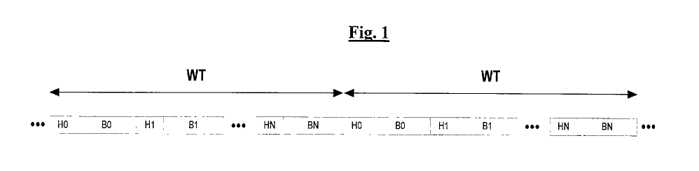

In a CircularBroadcast™-based system, each movie is divided into N+1 blocks, with each block being identified by a header, as shown in FIG. 1. The header information includes a bit-sequence denoting the start of a block, an index indicating the block's number within the movie, and the total number of blocks in the movie. Note that the only difference between this scheme and that presented in the OEID model is that the CircularBroadcast™ technique adds a modest number of bits, h, to each block as header information. The blocks of an encoded movie are then transmitted continuously within a particular channel. Once the end of the movie is reached, the server proceeds to transmit it once again from the beginning. That is, the movie is broadcast continuously, back-to-back.

FIG. 1, below, shows a CircularBroadcastTM file structure. A header that identifies the blocks position within the movie and the total number of blocks in the movie precedes each block. The total transmission time for each movie, or equivalently the turn-around time or wait time that the subscriber experiences from the time he selects a movie until he is able to watch it is denoted as WT.

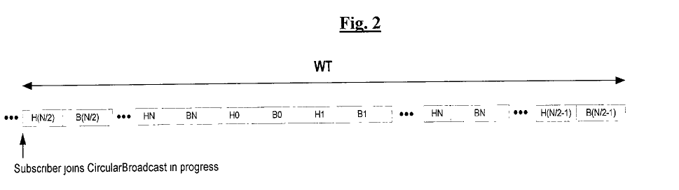

Since the blocks are identified by the header information, an unlimited number of subscribers may “eavesdrop” on the transmission at any point in time. For example, once a subscriber selects a movie, his set-top-box joins the transmission in progress. Once it detects the start bit sequence denoting the start of a block, it begins to store the subsequent blocks in it's high-capacity storage device. If the user joins the transmission after half of the movie has been broadcast, it would first download the second half of the movie, would then download the first half of the movie, and would then play the movie in correct order by pointing to the movies start location in memory. This process is depicted in FIG. 2.

FIG. 2, below, shows “Eavesdropping” on a CircularBroadcast in progress. WT is the guaranteed wait time.

Again, in order to serve a 400-movie catalog to a maximum of 3,200 customers (with a delay of at most 100 seconds) using the OEID model, 320 cable channels would be required. Clearly, allocating 320 channels to ensure VoD delivery of a 400-movie catalog is quite costly. Even if the 320 channels were available, the 3,200 customers that could be served would be a very small fraction of a typical cable service provider's subscriber base. Serving a larger number of subscribers would require a very powerful VoD server at the service provider's head-end premises and multiple hub servers at a more localized regional level (e.g., apartment complexes, suburbs, towns, cities, etc.)

The CircularBroadcast™ technique allows an unlimited number of subscribers to take advantage of VoD services without the need to replicate server resources and does so at a reduced number of required channels. The only sacrifices that must be made are in the guaranteed wait time WT and the fact that a mass storage device, such as a hard disk would be required at the subscriber terminal.

In order to illustrate the benefits of the CircularBroadcast™ technique, a mathematical analysis follows that compares this technique to the OEID model described above. For consistency purposes, the same technology parameters as for the OEID model are used. First, the case where a customer is willing to wait up to WT=750 seconds (12.5 minutes) for the availability of a two-hour movie of length L=3.6 GB (28.8 Gb) is considered. In this scenario, a total bandwidth of ┌L/WT┐=38.4 Mb/s (4.8 MB/s) is required to transmit the entire movie. Since this is precisely the bandwidth available on a single cable TV channel, one channel would be used to continuously broadcast each movie in the catalog.

At first glance, the above analysis would seem to indicate that a total of 400 channels would be needed to support a 400-movie library. However, the actual number of channels that would be needed can be reduced by a significant factor if we make use of movie access statistics. It is commonly accepted that a certain number of movies, X, in a catalog will account for a major percentage, Y, of viewing requests. For example, if we let X=40 and Y=90%, this would mean that 40 movies out of the 400-movie catalog would be requested 90% of the time. In the case at hand, the VoD service provider has to make sure that subscribers will be able to access the Top 40 movies in a T-VoD fashion with as short as possible turn-around-time, WT. One preferred way to do this would be to allocate a single channel to each one of the Top 40 movies. Each one of these channels would be transmitting a movie under the CircularBroadcast™ model. The subscriber can join a CircularBroadcast™ at any time and be guaranteed a wait time of just WT=750 seconds, for example. This requires a total of CT=40 channels for the top movies.

The above scheme guarantees that the most popular movies will be available within WT seconds of being requested. The next question is how to make the remaining 360 movies available to subscribers without allocating 360 additional channels. This is addressed by a pre-ordering mode whereby subscribers order the movie they would like to watch from this group understanding that the guaranteed turn-around time in this case would be longer than the 12.5 minutes guaranteed for the Top 40 movies.

For example, assume that the guaranteed turn-around-time for pre-orders is WTPO=24 hours. The service provider receives orders from its subscriber base and fills them through a scheduling algorithm. If a movie takes 12.5 minutes to transmit, as previously discussed, then in a 24-hour period a total of S=└WTPO/WT┘=115 slots would be available to fill S different movie orders per available channel. The number of subscribers that could receive each one of these movies would be unlimited, since the scheduling software multicasts movies to all those who ordered a particular title, ensuring simultaneous delivery to all of them. In the case of a 360-movie library, at most ┌360/115┐=4 channels would be required. The 4 channels is an upper bound since it assumes that the each and every movie in the least-watched library will be accessed during a 24-hour period. In practice, however, if on average only Z% of these movies are accessed during a 24-hour period, then the number of additional channels that are required can be lowered. If Z is 10%, we would only need CL=┌Z×360/115┐=1 channel to fill all pre-orders for the less-watched movies within a 24-hour period. Alternatively, if 4 channels had already been allocated, the extra bandwidth can be used to guarantee delivery of pre-ordered movies within a 6 hour period.

Summarizing the above discussions, the total number of channels required, C, for an efficient implementation of the CircularBroadcast™ technique is given by Equation 4, below.

Equation 4:

C=CT+CL

Equation 5:

CT=X

$$\text{Equation 6:}$$

$$CL = ⌈ Z \cdot ( ⌊ \frac{d}{L} \cdot m ⌋ - X ) \cdot {[ ⌊ \frac{WTPO}{WT} ⌋ ]}^{- 1} ⌉ .$$

In the above Equations 4-6, CT is the number of channels that must be allocated to the top X movies and CL is the number of channels that need to be allocated for the less-watched movies. The factor └d/L×m┘ corresponds to the total number of movies available in the catalog. Z is the average percentage of the less-watched movies that are requested in any 24-hour period, and S=└WTPO/WT┘ is the number of slots available for order fulfillment. As mentioned previously, d is the disk capacity, L is the movie length, m is the number of disks available, WT is the guaranteed wait or turn-around time for the top movies, and WTPO is the guaranteed turnaround time for pre-ordered movies. The right balance between the number of channels that would be used for true video-on-demand and for pre-orders could be dynamically adjusted by a backend system.

From the above description, the CircularBroadcast™ technique decouples the number of subscribers that can enjoy T-VOD for popular movie choices from the maximum number of streams that can be supported by either the server or the network. Under this model, access statistics are used to allow an unlimited number of subscribers to access VoD services through two different modes of operation, the T-VOD mode with a very short turn-around time (for example 12.5 minutes) and the pre-order mode with a longer turn-around time (for example 24 hours). A comparison of OEID and CircularBroadcast™ is presented in the Table 2, below. The table assumes the server-limited number of streams for the OEID model.

If a movie can be compressed to just 600 MB (for example, using the DiVX format) the advantages of the CircularBroadcast™ technique over the OEID are even more attractive. In this case the total number of movies in the library would be 2,400, distributed across the same number of disks as before, m=100. The OEID numbers presented in Table 2 would not change, as they are independent on the number of movies. The CircularBroadcast™ technique numbers could change depending on the use of smaller movie lengths. For example, (1) the WT could be reduced by a factor of 6 to 125 seconds while maintaining the same number of channels or (2) the number of required channels for top movies could be lowered to CT=┌X/61┐=7 while maintaining WT=750 seconds. The former case is denoted as CB-1 and the latter as CB-2. A comparison of the results of each case with the OEID model is presented in Table 3.

Table 2 shows a comparison of the OEID streaming VoD model and the CircularBroadcast™ model using the technology and movie library (MPEG-2) presented in [1] and X=40, Z=10%, WT=12.5 minutes, and WTPO=24 hours.

TABLE 2

| | OEID | | CB | |
|---|---|---|---|---|
| Maximum number of users that can be served | 3,200 | | Unlimited | |
| simultaneously | | | | |
| Maximum service turn-around time | 100 | s | 750 | s |
| Number of cable channels required (38.4 Mb/s | 320 | | 40 | |
| per channel) | | | | |
| Number of additional channels required for pre- | NA | | 1 | (4) |
| order service (upper-bound) | | | | |
| Total Number of Channels Required (upper- | 320 | | 41 | (44) |
| bound) | | | | |

| | | |
|---|---|---|
| Pre-Order service possible without major | No | Yes |
| modifications to the model | | |
| VCR functionality | Limited | Full |
| Hard Disk required at terminal box | No | Yes |

Table 3 shows a comparison of the OEID streaming VoD model and the CircularBroadcast™ model using the technology and movie library parameters presented in [1] (changing the movie length to L=600 MB—typical of the DiVX format), X=40, Z=10% and WTPO=24 hours. The upper-bounds refer to the case where each one of the less-watched movies (2360) would be pre-ordered in any WTPO period.

TABLE 3

| | OEID | | CB-1 | | CB-2 | |
|---|---|---|---|---|---|---|
| Maximum number of users that can | 3,200 | | Unlimited | | Unlimited | |
| be served simultaneously | | | | | | |
| Size of the Movie Library | 2,400 | | 2,400 | | 2,400 | |
| Maximum service turn-around time | 100 | s | 125 | s | 750 | s |
| Number of cable channels required | 320 | | 40 | | 7 | |
| (38.4 Mb/s per channel) | | | | | | |
| Number of additional channels | NA | | 1 | (4) | 3 | (21) |
| required for pre-order service | | | | | | |
| (upper bound) | | | | | | |
| Total Number of Channels | 320 | | 41 | (44) | 10 | (31) |
| Required (upper-bound) | | | | | | |

3. VOD Business Model Enabled by CircularBroadcast™

This section presents two preferred VOD business models for service providers using the CircularBroadcast™ technique. The models are not mutually exclusive and are meant only as examples of what the technology allows. The models require a limited amount of one-to-one communication to take place between a terminal and the server to allow for order validation and fulfillment.

3.1 NowVideo™

For a per movie fee, a subscriber would be able to download, within a pre-specified time period (e.g., 15 minutes), any movie from a specific list of films compiled by the service provider. The list would constitute a sort of “Top 10” or “Top 40” selection of movies in high-demand. The actual number of movies on the list would depend on the amount of bandwidth available to the service provider. Once downloaded, the subscriber will have a pre-specified period of time to watch the movie (e.g., 48-hours) before the movie “expires”. This allows the VoD experience to be similar in nature to renting a video, since the movie may be watched as many times as the user desires within the “rental” period—this is in sharp contrast to streaming VoD models where the subscriber can just watch the movie just once without incurring in additional charges.

The sequence of events in the NowVideo experience is as follows: (1) the user accesses the VoD system menu via his set-top box and places an order; (2) the server validates the subscriber's access to the VoD service; (3) the set-top box tunes to the appropriate channel and joins a CircularBroadcast in progress; (4) the set-top box notifies the server that it has successfully completed downloading the movie; (5) the server debits the subscriber's account; and, finally, (6) the set-top box processor reads the movie's first block and starts the decompression process delivering the movie in real-time to the TV set.

3.2 AlwaysVideo™

For a flat monthly fee, a subscriber creates a personalized prioritized list of movies he would like to see in the near future. Within a pre-specified period (e.g., 24-hours) the first N movies in his list would be downloaded into his set-top box. The subscriber would then have an unlimited amount of time to view any of the N movies that have been downloaded onto his box. The subscriber will have the capability of “expiring” a movie once he has finished watching it. If the user does not expire the movie, it will remain on his hard disk for a maximum of 48 hours after it has first been watched. Once the movie expires, the next movie on his list will be downloaded onto his machine within the pre-specified time period. This model will ensure that the user will always have at least N new movies at his disposal in any given 24-hour period. This model will eliminate due dates and late charges associated with video rental services.

The sequence of events in the AlwaysVideo™ experience is as follows: (1) the user accesses the VoD system menu via his set-top box and/or the service provider's website and adds movies to his personalized wish-list; (2) the server validates the subscriber's access to the VoD service; (3) the server schedules the download of the top N movies in the subscriber's wish-list; (4) the server provides the set-top box with the scheduled download information; (5) the set-top box tunes to the appropriate channels at the appropriate tines to join the wish-list movie multicast; (6) the set-top box notifies the server that it has successfully completed downloading the movie (the movie is immediately available for watching after this); (7) once a movie is expired, the server schedules delivery of the next movie in the subscriber's wish-list.

Although the invention has been described with reference to specific embodiments and applications, those skilled in the art will appreciate that many modifications and variations are possible without departing from the scope of the invention. For example, the above description details the application the CircularBrodcast™ technique to T-VoD systems based on a digital via hybrid fiber coaxial Cable TV infrastructure. However, the technique is equally applicable to other forms of media transmissions (interactive games, music, etc.) and is also suitable for application to digital wireless cable, terrestrial, and direct broadcast satellite distribution infrastructures.

All such modifications and variations are intended to be encompassed by the following claims.

We claim:

1. A method of broadcasting a plurality of movies or other media to an unlimited number of subscribers through a digital communications network having a limited bandwidth comprising the steps of:
selecting a first group of digitized movies each divided into a plurality of temporally related frames;
transmitting the plurality of temporally related frames of the first group of digitized movies through the digital communications network in a compressed format, wherein the step of transmitting includes transmitting a header along with each of the plurality of temporally related frames wherein the header identifies the temporal sequence of the frames; and
re-transmitting the plurality of temporally related frames of the first group of digitized movies through the digital communications network in the compressed format immediately upon completion of the step of transmitting the plurality of temporally related frames of the first group of digitized movies.

2. The method of claim 1, further comprising the steps of:
receiving at least one request for each movie in a second group of digitized movies each divided into a plurality of temporally related frames;
transmitting the second group of digitized movies without repetition only once in a fixed period of time, wherein the fixed period of time that is greater than the time of transmission.

3. A set-top box configured to store and regenerate a movie signal received from the method of broadcasting of claim 1 or 2.

4. A set-top box suitable to receive a compressed video signal comprising:
a receiver configured to accept compressed video signals that are divided into frames and include a sequence header;
a memory operationally coupled with the receiver and configured to store the compressed video signals;
an interface configured to receive a movie selection from a user;
a controller operationally coupled with the receiver, the memory and the user interface and configured to direct the receiver to accept immediately the movie selection from a repeated broadcast of a plurality of movies.

5. The set-top box of claim 4, further comprising a transmitter operationally coupled with the controller, wherein the controller is further configured to transmit a request for the movie selection from the user to a service provider and to direct the receiver to accept the movie selection from a single broadcast of the selected movie in a fixed period of time.
